(19) United States
(12) Patent Application Publication
(10) Pub. No.: US 2025/0245085 A1
(43) Pub. Date: Jul. 31, 2025

(54) PROCESSOR ERROR DETECTION WITH ASSERTION REGISTERS

(71) Applicant: Akeana, Inc., Santa Clara, CA (US)

(72) Inventors: Ricardo Ramirez, Sunnyvale, CA (US); Rabin Sugumar, Sunnyvale, CA (US)

(73) Assignee: Akeana, Inc., Santa Clara, CA (US)

(21) Appl. No.: 19/074,782

(22) Filed: Mar. 10, 2025

Related U.S. Application Data
(63) Continuation-in-part of application No. 18/666,884, filed on May 17, 2024.
(60) Provisional application No. 63/735,937, filed on Dec. 19, 2024.
(60) Provisional application No. 63/730,997, filed on Dec. 12, 2024.
(60) Provisional application No. 63/719,841, filed on Nov. 13, 2024.
(60) Provisional application No. 63/714,529, filed on Oct. 31, 2024.
(60) Provisional application No. 63/702,192, filed on Oct. 2, 2024.
(60) Provisional application No. 63/699,245, filed on Sep. 26, 2024.
(60) Provisional application No. 63/691,351, filed on Sep. 6, 2024.
(60) Provisional application No. 63/690,822, filed on Sep. 5, 2024.
(60) Provisional application No. 63/687,795, filed on Aug. 28, 2024.
(60) Provisional application No. 63/679,685, filed on Aug. 6, 2024.
(60) Provisional application No. 63/679,192, filed on Aug. 5, 2024.
(60) Provisional application No. 63/653,402, filed on May 30, 2024.
(60) Provisional application No. 63/640,921, filed on May 1, 2024.
(60) Provisional application No. 63/641,045, filed on May 1, 2024.
(60) Provisional application No. 63/570,281, filed on Mar. 27, 2024.
(60) Provisional application No. 63/564,529, filed on Mar. 13, 2024.
(60) Provisional application No. 63/563,492, filed on Mar. 11, 2024.
(60) Provisional application No. 63/563,102, filed on Mar. 8, 2024.
(60) Provisional application No. 63/556,944, filed on Feb. 23, 2024.
(60) Provisional application No. 63/556,951, filed on Feb. 23, 2024.
(60) Provisional application No. 63/605,620, filed on Dec. 4, 2023.
(60) Provisional application No. 63/602,514, filed on Nov. 24, 2023.
(60) Provisional application No. 63/547,574, filed on Nov. 7, 2023.
(60) Provisional application No. 63/547,404, filed on Nov. 6, 2023.
(60) Provisional application No. 63/546,769, filed on Nov. 1, 2023.
(60) Provisional application No. 63/545,961, filed on Oct. 27, 2023.
(60) Provisional application No. 63/542,797, filed on Oct. 6, 2023.
(60) Provisional application No. 63/526,009, filed on Jul. 11, 2023.
(60) Provisional application No. 63/521,365, filed on Jun. 16, 2023.
(60) Provisional application No. 63/471,283, filed on Jun. 6, 2023.
(60) Provisional application No. 63/467,335, filed on May 18, 2023.
(60) Provisional application No. 63/764,198, filed on Feb. 27, 2025.
(60) Provisional application No. 63/765,094, filed on Feb. 28, 2025.
(60) Provisional application No. 63/745,432, filed on Jan. 15, 2025.

(51) Int. Cl. G06F 11/07; G06F 11/362

(52) U.S. Cl. CPC G06F 11/0751; G06F 11/3656

(57) ABSTRACT

Techniques for debugging errors in a processor are disclosed. One or more processors are accessed. Each processor within the one or more processors includes a set of assertion registers. A processor within the one or more processors executes one or more instructions. An assertion logic detects an error condition in the processor. The detecting occurs during the executing. The error condition is recorded. The recording is based on one or more bits in the set of assertion registers. A hardware interface reads the one or more bits in the set of assertion registers. The one or more bits indicate the error condition to the hardware interface. The executing includes a communication protocol between the processor and a slave device. The error condition comprises an incorrect value in a credit buffer. The credit buffer controls a number of transactions allowed between the processor and the slave device.

### RELATED APPLICATIONS

This application claims the benefit of U.S. provisional patent applications “Processor Error Detection With Assertion Registers” Ser. No. 63/563,492, filed Mar. 11, 2024, “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, and “Transformed Activation Function With ISA Extension” Ser. No. 63/765,094, filed Feb. 28, 2025.

This application is also a continuation-in-part of U.S. patent application “Architectural Reduction Of Voltage And Clock Attack Windows” Ser. No. 18/666,884, filed May 17, 2024, which claims the benefit of U.S. provisional patent applications “Architectural Reduction Of Voltage And Clock Attack Windows” Ser. No. 63/467,335, filed May 18, 2023, “Coherent Hierarchical Cache Line Tracking” Ser. No. 63/471,283, filed Jun. 6, 2023, “Direct Cache Transfer With Shared Cache Lines” Ser. No. 63/521,365, filed Jun. 16, 2023, “Polarity-Based Data Prefetcher With Underlying Stride Detection” Ser. No. 63/526,009, filed Jul. 11, 2023, “Mixed-Source Dependency Control” Ser. No. 63/542,797, filed Oct. 6, 2023, “Vector Scatter And Gather With Single Memory Access” Ser. No. 63/545,961, filed Oct. 27, 2023, “Pipeline Optimization With Variable Latency Execution” Ser. No. 63/546,769, filed Nov. 1, 2023, “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, “Cache Snoop Replay Management” Ser. No. 63/605,620, filed Dec. 4, 2023, “Processing Cache Evictions In A Directory Snoop Filter With ECAM” Ser. No. 63/556,944, filed Feb. 23, 2024, “System Time Clock Synchronization On An SOC With LSB Sampling” Ser. No. 63/556,951, filed Feb. 23, 2024, “Malicious Code Detection Based On Code Profiles Generated By External Agents” Ser. No. 63/563, 102, filed Mar. 8, 2024, “Processor Error Detection With Assertion Registers” Ser. No. 63/563,492, filed Mar. 11, 2024, “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, and “Circular Queue Management With Nondestructive Speculative Reads” Ser. No. 63/641,045, filed May 1, 2024.

Each of the foregoing applications is hereby incorporated by reference in its entirety.

### FIELD OF ART

This application relates generally to processor debug and more particularly to processor error detection with assertion registers.

### BACKGROUND

For millennia, humans have devised techniques for counting things. As a result, a variety of numbering systems and representations have been devised that are based on the needs of the humans who devised them. At one end of the spectrum is the “one, two, many” numbering system attributed to the Piraha tribe of the Amazon rainforest. This system has no words for numbers larger than two and provides sufficient quantification, adequate for tribal purposes. At the other end of the counting spectrum are the numbering systems that allow for exact quantification of objects. These latter systems include Roman numerals, Arabic numerals, and so on. Large numbers can be recorded by displaying all of the digits in the number or by using notations such as scientific notation and engineering notation. These latter numbering systems and representations are critical to human endeavors including commerce, healthcare, design, and construction. A proper and consistent choice of numbering system is essential to human success.

To help keep track of quantifies, sizes, and weights of the objects, standard units are used. An old standard of units is the English system. The main standard of units that is used worldwide is the Metric system. Conversion factors enable “translations” between English units and Metric units. Thus, 1 inch equals 2.54 centimeters, 1 pound equals 0.454 kilograms, and so on. These conversions enable designers, for example, to convert design specifications based on one set of units to the other set of units. However, disastrous results can ensue when one set of units is used for part of a design while the other set of units is used for another part of the design. In 1998, NASA launched a robotic space probe known as the Mars Climate Orbiter. The orbiter was designed to study the Martian climate, atmosphere, and surface changes, as well as to function as a communications relay for later probes. However, nine months after the launch, communication with the orbiter was lost as it maneuvered into orbit around Mars. It was later discovered that NASA had used metric units in its specifications for a critical piece of software on the orbiter, but the vendor had used US (English) standard units to develop the software. Thus, when the software was used in the landing process for the orbiter, the calculations were significantly incorrect.

Errors of all kinds, including design errors or unit errors, occur every day in every context and human endeavor. Many errors are small and inconsequential, while other errors can result in catastrophic failures. Finding errors before they lead to significant losses of time, money, or even lives can be challenging. There are many reasons for our difficulties in finding and correcting errors. Blind spots, biases, overly broad contexts, time pressures, overreliance on memory, visual fatigue, distractions, and imperfect testing tools can all contribute to making errors challenging to locate. Finding and addressing errors require both vigilance and multiple methodologies that can be applied routinely and dispassionately.

### SUMMARY

Electronic devices are used daily by individuals around the globe. The variety of electronics is seemingly endless, ranging from small and simple devices to large and complex ones. The most popular electronic devices include personal electronic devices such as computers, handheld electronic devices such as smartphones and tablets, and wearable electronic devices such as smartwatches. The electronic devices are also present in household devices including kitchen and cleaning appliances; vehicles for personal, private, and mass transportation; and medical equipment; among many other familiar devices. Each of these devices contains a processor chip, circuit, or core. The processors included in the devices enable them to perform essential, useful, and desirable tasks and applications. As the processors are executing the tasks and applications, the processors can encounter an unexpected or error condition. An error condition can result from one or more bugs in an application, a bug in electronic circuits associated with the processor, or both. That is, an application can cause one or more errors to be manifested in the hardware, such as the hardware causing an unexpected application execution exception, an invalid result, a memory fault, a protocol violation, and so on. In order to detect a source on an error condition, a variety of debugging or “debug” techniques can be applied. The error conditions can be attributed to buggy software, hardware logic errors, runtime conditions, etc. Further, the error conditions can result from the range of applications and programs that are executing on a processor at a given time. By recording an error condition in one or more assertion registers, bits associated with the assertion registers can be read and analyzed. The analysis can be used to identify one or more causes of the error condition.

Techniques for processor error detection with assertion registers are disclosed. One or more processors are accessed. The processor cores can include one or more cores within an integrated circuit, an FPGA, an ASIC, and so on. Each processor within the one or more processors includes a set of assertion registers. The assertion registers include bits that can be set to indicate an error condition such as a data collision, an incorrect buffer value, a clock cycle compression or elongation, and the like. A processor within the one or more processors executes one or more instructions. The instructions can fetch and store data, process data, communicate with devices, etc. The executing includes a communication protocol between the processor and a slave device. An assertion logic detects an error condition in the processor, wherein the detecting occurs during the executing. The error condition can be associated with the processor, a program executing on the processor, and so on. The error condition is recorded. The recording is based on one or more bits in the set of assertion registers. A hardware interface reads the one or more bits in the set of assertion registers. The one or more bits indicate the error condition to the hardware interface.

A processor-implemented method for debug is disclosed comprising: accessing one or more processors, wherein each processor within the one or more processors includes a set of assertion registers; executing, by a processor within the one or more processors, one or more instructions; detecting, by an assertion logic, an error condition in the processor, wherein the detecting occurs during the executing; recording the error condition, wherein the recording is based on one or more bits in the set of assertion registers; and reading, by a hardware interface, the one or more bits in the set of assertion registers, wherein the one or more bits indicate the error condition to the hardware interface. In embodiments, the executing includes a communication protocol between the processor and a slave device. In embodiments, the error condition comprises an incorrect value in a credit buffer, wherein the credit buffer controls a number of transactions allowed between the processor and the slave device.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for processor error detection with assertion registers.

FIG. 2 is a flow diagram for error condition handling.

FIG. 3 is an infographic for processor error detection with assertion registers.

FIG. 4 is an illustration of error conditions.

FIG. 5 is a block diagram illustrating a multicore processor.

FIG. 6 is a block diagram for a pipeline.

FIG. 7 is a first example of error detection.

FIG. 8 is a second example of error detection.

FIG. 9 is a third example of error detection.

FIG. 10 is a system diagram for processor error detection with assertion registers.

### DETAILED DESCRIPTION

Techniques for processor error detection with assertion registers are disclosed. A processor such as a standalone processor, a processor chip, a processor core, a processor on a system-on-a-chip (SoC), and so on can be used to perform various data processing tasks. These data processing tasks can comprise applications from business, research, personal, government, or another usage. An error condition can occur while one or more applications, codes, an operating system, etc. are executing on a processor. The error condition, or “bug,” can occur due to an error in the application or code, an error in logic associated with the processor, a communications protocol error, and so on. The error condition can further be associated with an operating condition. An operating condition can include a software load on the processor, voltage events such as overvoltage spikes or undervoltage dips, clocking issues, and the like. Determining the origin or root cause of the error condition can be extremely difficult, particularly when the error condition is intermittent. A wide variety of debugging or “debug” techniques have been developed to identify bugs in software. Software techniques have ranged from adding output statements into code such as, “Go to here in Loop A,” to sophisticated tracing and debugging tools. Hardware techniques can be more difficult to implement. Further, a given application or code executing can generate one or more error conditions in the processor, which can cause runtime errors in an application, an operating system, a code stream, etc.

One or more processors are accessed. A processor can include one or more processor cores. Each processor within the one or more processors includes a set of assertion registers. Each assertion register includes one or more bits that can be set based on an occurrence of an error condition. A processor within the one or more processors executes one or more instructions. The instructions can be associated with an application, a program, an operating system, and the like. An assertion logic detects an error condition in the processor. The detecting occurs during the executing. An error condition can include a data collision, an incorrect buffer value, a compressed or elongated clock cycle, and so on. The error condition can also include a processor operating event such as a voltage droop or voltage spike. The error condition can further include a data handling error such as a full FIFO or an empty FIFO. The error condition can include an incorrect pointer. The incorrect pointer can point to an invalid storage address, a restricted address, etc. The error condition is recorded. The recording is based on one or more bits in the set of assertion registers. The one or more bits can be set based on the type of error condition, a plurality of error conditions, a severity of conditions, etc. The set of assertion registers can include one or more D flip-flops. The bits associated with the assertions include one or more sticky bits, where the sticky bits include persistent bits. The sticky bits retain their value after a warm reset of the processor. A hardware interface reads the one or more bits in the set of assertion registers. The one or more bits indicate the error condition to the hardware interface. The one or more bits can be analyzed, submitted for root-cause analysis, and so on.

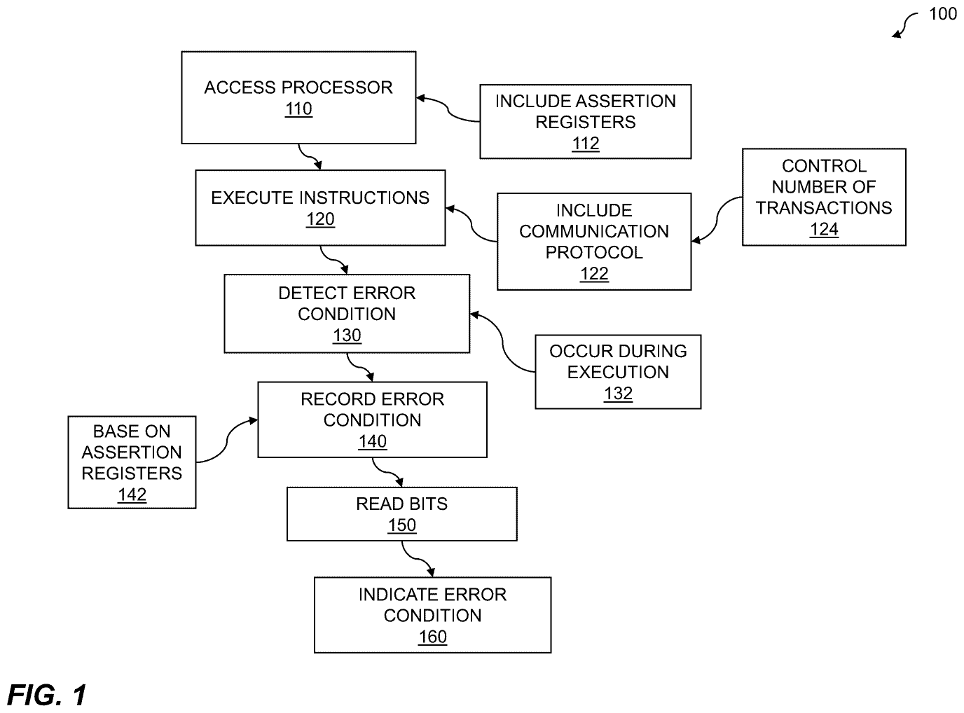

FIG. 1 is a flow diagram for processor error detection with assertion registers. The processor can be executing one or more instructions associated with one or more applications, codes, an operating system, and so on when an error condition is detected by assertion logic. The error condition, among other causes, can be based on a data collision between the processor or a primary and a secondary device. The error condition can also be based on processor operating conditions such as operating voltages or current, processor temperature, and the like. The error condition is recorded in a set of assertion registers. The set of assertion registers can be based on data or “D” flip-flops. The D flip-flops can include one or more sticky bits or persistent bits. The one or more sticky bits retain their value after a warm reset of the processor. A hardware interface reads the one or more bits in the set of assertion registers. The one or more bits indicate the error condition to the hardware interface. The one or more bits can be analyzed, processed, and so on to determine a root cause for the error condition. The analysis, processing, etc. can be used to debug the processor, debug the software running on the processor, etc.

The flow 100 includes accessing 110 one or more processors. The one or more processors can include an integrated circuit or chip, a multichip processor, one or more processor cores within an integrated circuit, an FPGA, an ASIC, and so on. In embodiments, a processor core can include a RISC-V™ processor core. In the flow 100, the one or more processors includes a set of assertion registers 112. The assertion registers include bits that can be set to indicate an error condition. The number of bits within an assertion register can be substantially similar to a number of possible error conditions. In embodiments, the error condition can include a data collision between the processor and a slave or secondary device. A data collision can occur when the processor (or primary) and the secondary processor try to send data at substantially the same time, when multiple processor and/or devices try to send data, and so on. In embodiments, the error condition can include a compressed clock cycle within the processor. The compressed clock cycle can cause a clock signal to arrive early. An early clock cycle can cause data to be missed; incorrect data to be sent, received, or captured; and the like. In other embodiments, the error condition can include an elongated clock cycle within the processor. The elongated clock cycle, similar to the compressed clock cycle, can cause one or more data errors. The error condition can be associated with one or more registers associated with the one or more processors. In embodiments, the error condition can include a full first in, first out (FIFO) register. The FIFO register can contain stale data, incorrect data, and so on. The FIFO register can be missing data. In embodiments, the error condition can include an empty FIFO register. An empty FIFO register can indicate that data has not been loaded or is late being loaded, the data is missing, etc. Addresses used to access data, references to data, and so on can cause an error condition. In other embodiments, the error condition comprises an incorrect pointer.

The flow 100 includes executing 120, by a processor within the one or more processors, one or more instructions. The instructions that are executed can include instructions associated with an app, an application program or code, an operating system, etc. The instructions can fetch and store data, process data, communicate with devices, etc. In the flow 100, the executing can include a communication protocol 122 between the processor and a secondary or slave device. The communication protocol can include an industry standard protocol, a propriety protocol, and so on. The communication protocol can include a wired, wireless, or hybrid communication protocol. The communication protocol can generate an error condition. In the flow 100, the error condition comprises an incorrect value in a credit buffer, wherein the credit buffer controls a number of transactions 124 allowed between the processor and the secondary or slave device. An incorrect value in the credit buffer can include an out-of-limits number such as an overvalue or an undervalue, an undefined value, and so on.

The flow 100 includes detecting 130, by an assertion logic, an error condition in the processor. The assertion logic can include logic within a processor, logic external to the processor, logic shared by two or more processors, and so on. The assertion logic can receive signals, flags, semaphores, etc. from one or more elements associated with the processor. In the flow 100, the detecting occurs during the executing 132. The assertion logic can detect one or more error conditions using one or more sensors, detectors, and so on. In embodiments, the assertion logic can include a voltage detector. The voltage detector can include a detector for operating voltage, RMS voltage, instantaneous voltage, and so on. The voltage detector can detect voltage anomalies. In embodiments, the error condition can include a voltage droop within the processor. A voltage droop can occur when a processor is overly busy, a power supply encounters an operating problem, a power grid has not been adequately designed or implemented, and the like. In other embodiments, the error condition can include a voltage spike within the processor. A voltage spike can be associated with noise coupled into the processor, switching of circuits and equipment external to the processor, etc.

The flow 100 includes recording the error condition 140. The recording can include writing an error condition to storage such as a scratchpad, a register file, a cache, a shared cache, shared memory accessible to a plurality of processors, and so on. In the flow 100, the recording is based on one or more bits in the set of assertion registers 142. The assertion registers can be implemented using a variety of circuit techniques. In embodiments, the set of assertion registers includes one or more D flip-flops. The D flip-flops can be implemented using static circuits, dynamic circuits, and the like. A plurality of D flip-flop types can be used within the set of assertion registers. In embodiments, the one or more bits can include one or more sticky bits. Once set or reset, the sticky bits can retain their state. In a usage example, an error condition such as a compressed clock cycle causes a bit to be set in an assertion register. The bit can remain set until the bit has been processed, where the processing can include one or more debugging tasks.

The flow 100 includes reading 150, by a hardware interface, the one or more bits in the set of assertion registers. The reading can be accomplished by accessing the set of assertion registers. The accessing can be accomplished by the hardware interface making a request to the processor to receive the one or more bits, an access such as a direct memory access (DMA), a referenced access using a pointer, and so on. In the flow 100, the one or more bits indicate the error condition 160 to the hardware interface. Individual bits can be associated with a type of error condition, the bits can present a code that references a type of error condition, and the like. The one or more bits in the set of assertion registers can be used for a variety of purposes. In embodiments, the hardware interface can be a debugger. The debugger can be used to debug the processor, the secondary or slave device, the communication protocol used between the processor and the secondary device, etc. The debugger can control operation of the processor such as single-stepping the processor where each operation of the processor can be executed and monitored, slowing down the processor operation, etc. The debugger can also be used to debug the application, code, operating system, etc. executing on the processor.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

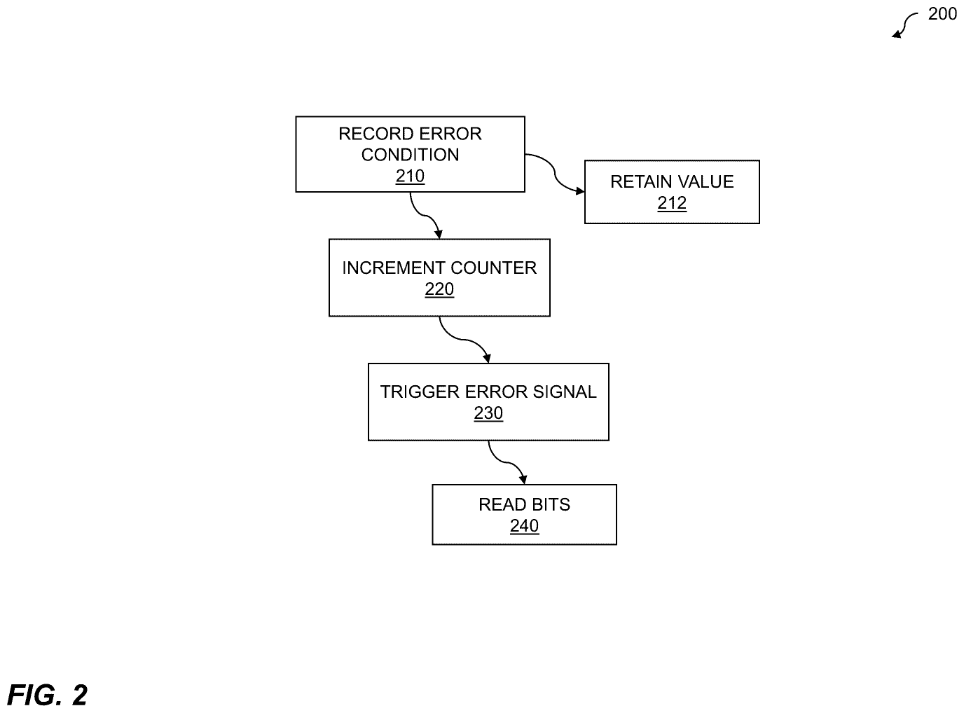

FIG. 2 is a flow diagram for error condition handling. Error condition handling enables processor error detection with assertion registers. The error conditions can be attributed to buggy software, hardware logic errors, runtime conditions, malware, etc. The error conditions can result from one or more of the range of applications and programs that are executing on a processor at a given time. The error conditions can be attributed to external factors, such as voltage spikes, noise, and droops. For example, a hacker can attempt to modify a system's voltage in order to put the processor into a state from which information can be extricated. Disclosed embodiments can protect against such attacks. One or more processors are accessed. Each processor within the one or more processors includes a set of assertion registers. A processor within the one or more processors executes one or more instructions. An assertion logic detects an error condition in the processor. The detecting occurs during the executing. The error condition is recorded. The recording is based on one or more bits in the set of assertion registers. A hardware interface reads the one or more bits in the set of assertion registers. The one or more bits indicate the error condition to the hardware interface.

The flow 200 includes recording an error condition 210. Discussed above and throughout, the error condition can result from a number of various hardware and software bugs, environmental conditions, malicious attacks, and so on. The error condition can be detected by various techniques, examples of which are described later. The error condition can be recorded by an assertion register. The assertion register can include one or more “sticky bits,” which require certain conditions to be met before they are deasserted. In embodiments, the one or more sticky bits can include one or more persistent bits. The one or more persistent bits can remain set or reset through a change of a state associated with the processor. In the flow 200, the one or more sticky bits can retain their value 212 after a warm reset of the processor. A warm reset can include the processor retaining certain register values after the reset has been completed.

In other embodiments, the one or more bits can comprise a counter. The counter can be set, reset, and so on. In the flow 200, the recording includes incrementing the counter 220. The counter can be incremented to indicate a number of occurrences of a type of error condition, a total number of error conditions, etc. The counter reaching a certain value can trigger an error signal 230. The certain value can be a threshold, a limit, a specified number, and so on for one or more error conditions tracked in the assertion register. Some embodiments comprise triggering an error signal when the counter exceeds a first threshold. In the flow 200, the error signal being triggered can cause the assertion register bits to be read 240. The assertion bits can be read by a hardware interface, a software interface, debugging logic, and so on. The assertion bits can be used to guide various processor actions such as debugging code, debugging hardware, resetting processes, restoring operations, and so on.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

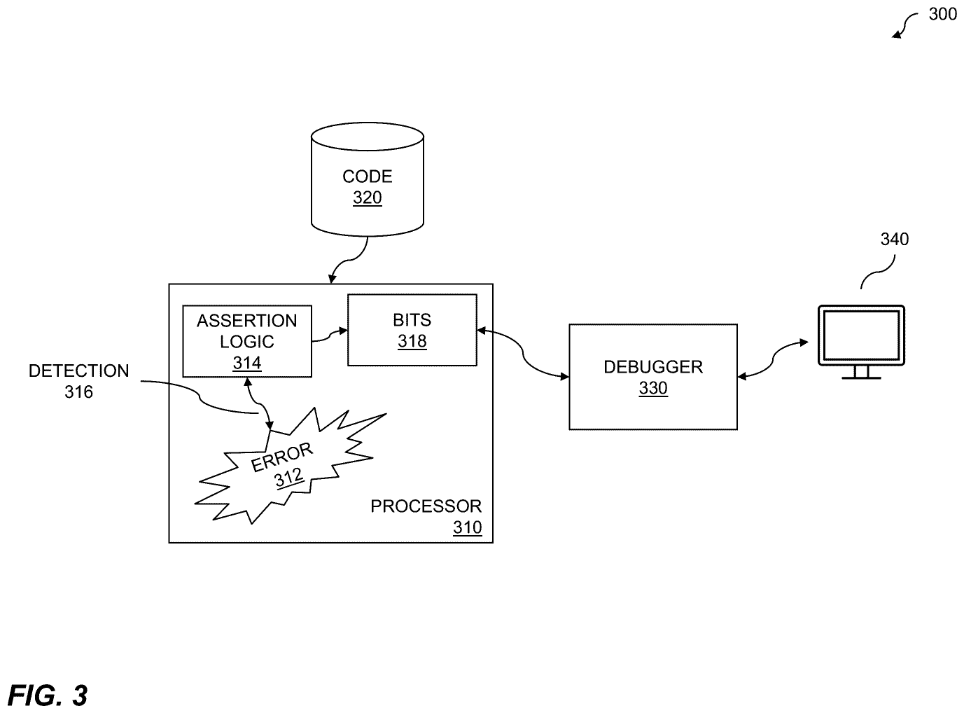

FIG. 3 is an infographic for processor error detection with assertion registers. The infographic 300 includes diagrammatic blocks that can be used for detecting and debugging processor errors. One or more processors are accessed. Each processor within the one or more processors includes a set of assertion registers. A processor within the one or more processors executes one or more instructions. An assertion logic detects an error condition in the processor. The detecting occurs during the executing. The error condition is recorded. The recording is based on one or more bits in the set of assertion registers. A hardware interface reads the one or more bits in the set of assertion registers. The one or more bits indicate the error condition to the hardware interface.

The infographic 300 includes a processor 310. The processor can be a standalone processor, a processor core, a multichip processor, and so on. The processor can include assertion logic 314 for capturing information reported by various error detection techniques 316. The error detection techniques can include data collision detection, incorrect buffer values, distorted clock cycles, processor voltage droop or voltage spike, data handling errors such as a full FIFO or an empty FIFO, and incorrect pointers, to name just a few. The assertion logic can set one or more bits 318 in an assertion register. The bits can comprise sticky bits that maintain their value through various processor state changes. When code 320 is executed on processor 310, an error condition 312 is detected and processed by assertion logic 314, which sets one or more bits 318. The code can comprise any type of compiled program, interrupt handling routine, operating system subroutine, machine learning model or portion of a machine learning model, etc. The code can comprise malicious software inserted into the processor. In this case, the code can cause the error condition that was detected. The one or more bits can trigger a debugger 330 to start a debug action, such as single stepping, data logging, operation retry, register flush and restart, and so on. The debugger 330 can include integrated hardware in or coupled to the processor, a dedicated hardware debugger interface, a software debugger interface, a network connected debugger interface, etc., which can result in debug data being displayed on display 340 for monitoring, user action, logging, and so on.

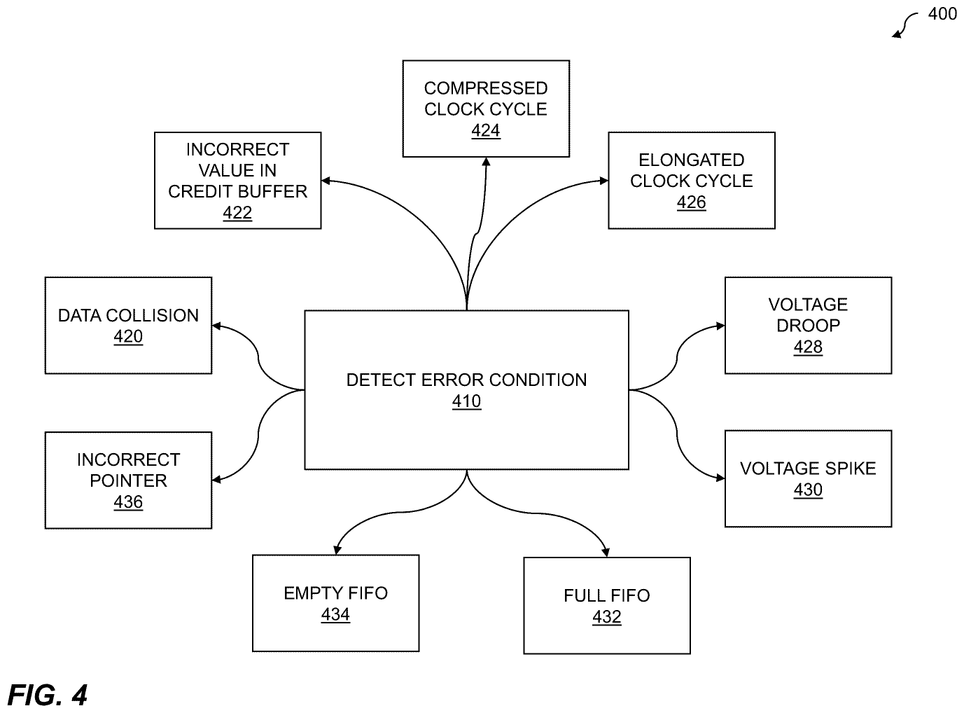

FIG. 4 is an illustration of error conditions. Various error conditions are shown in illustration 400 that can be handled by processor error detection using assertion registers. One or more processors are accessed. Each processor within the one or more processors includes a set of assertion registers. A processor within the one or more processors executes one or more instructions. An assertion logic detects an error condition in the processor. The detecting occurs during the executing. The error condition is recorded. The recording is based on one or more bits in the set of assertion registers. A hardware interface reads the one or more bits in the set of assertion registers. The one or more bits indicate the error condition to the hardware interface.

In the illustration 400, an error condition is detected 410. Various errors can be detected by the processor. An error condition can be caused by data collision 420, which can include data collision between the processor, or primary device, and a secondary device, for example, if both devices attempt to control a bus at the same time. An error condition can be caused by an incorrect value in a credit buffer 422. A credit buffer can control the number of transactions allowed between the processor and the slave device. An error condition can be caused by various clocking issues, such as a compressed clock cycle 424 or an elongated clock cycle 426. For example, a compressed clock cycle can cause a clock signal to arrive early. An early clock cycle can cause data to be missed; incorrect data to be sent, received, or captured; and the like. An elongated clock cycle similarly can cause one or more data errors, logic errors, sequence errors, and so on.

An error condition can be caused by processor operating conditions, such as operating voltages or current, processor temperature, and the like, being out of specification. This can include voltage droop 428 and/or voltage spike 430. Operating conditions being out of specification can be a result of hardware design issues, environmental issues, software overloading issues, etc. An error condition can be caused by unexpected register states, such as a full FIFO 432, an empty FIFO 434, or an incorrect pointer 436. If the processor tries to write data in a full FIFO or read data from an empty FIFO, a data handling error can occur. If an incorrect pointer causes the processor to read or write data to/from an invalid storage address, a restricted address, etc., a pointer error can occur. Additional error conditions and detections are described later.

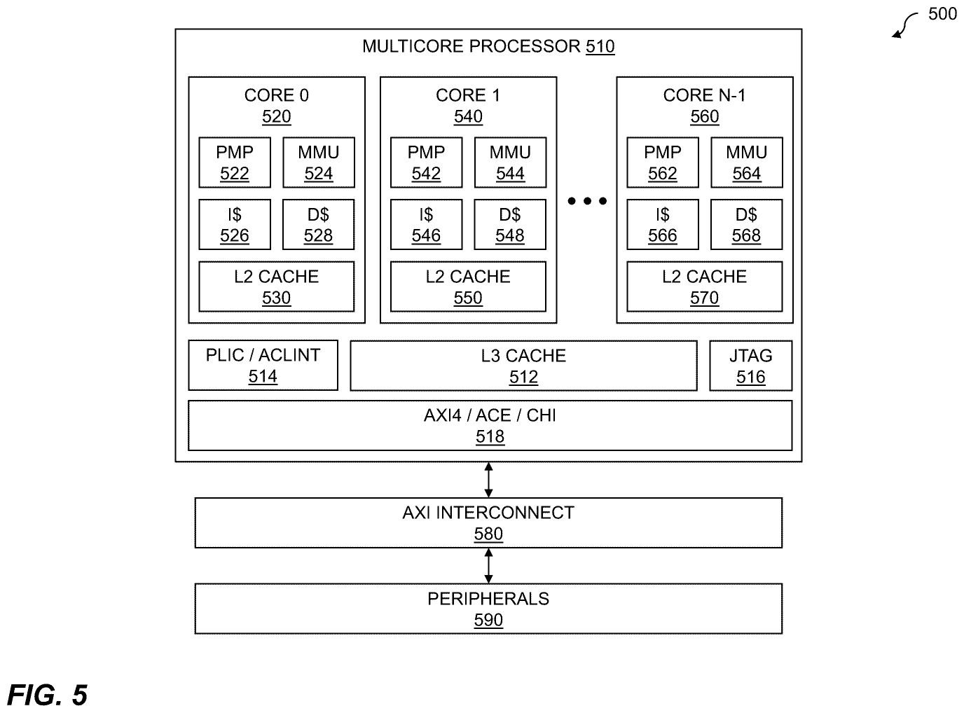

FIG. 5 is a block diagram illustrating a multicore processor. The processor can include a multi-core processor, where two or more processor cores can be included. The processor, such as a RISC-V™ processor, can include a variety of elements. The elements can include processor cores, one or more caches, memory protection and management units, local storage, and so on. The elements of the multicore processor can further include one or more of a private cache, a test interface such as a joint test action group (JTAG) test interface, one or more interfaces to a network such as a network-on-chip, shared memory, peripherals, and the like. The multicore processor supports error detection with assertion registers. One or more processors are accessed. Each processor within the one or more processors includes a set of assertion registers. A processor within the one or more processors executes one or more instructions. An assertion logic detects an error condition in the processor. The detecting occurs during the executing. The error condition is recorded. The recording is based on one or more bits in the set of assertion registers. A hardware interface reads the one or more bits in the set of assertion registers. The one or more bits indicate the error condition to the hardware interface.

The block diagram 500 can include a multicore processor 510. The multicore processor can comprise two or more processors, where the two or more processors can include homogeneous processors, heterogeneous processors, etc. In the block diagram, the multicore processor can include N processor cores such as core 0 520, core 1 540, core N−1 560, and so on. Each processor can comprise one or more elements. In embodiments, each core, including cores 0 through core N−1, can include a physical memory protection (PMP) element, such as PMP 522 for core 0; PMP 542 for core 1, and PMP 562 for core N−1. In a processor architecture such as the RISC-V™ architecture, PMP can enable processor firmware to specify one or more regions of physical memory such as cache memory of the shared memory, and to control permissions to access the regions of physical memory. The cores can include a memory management unit (MMU) such as MMU 524 for core 0, MMU 544 for core 1, and MMU 564 for core N−1. The memory management units can translate virtual addresses used by software running on the cores to physical memory addresses with caches, the shared memory system, etc.

The processor cores associated with the multicore processor 510 can include caches such as instruction caches and data caches. The caches, which can comprise level 1 (L1) caches, can include an amount of storage such as 16 KB, 32 KB, and so on. The caches can include an instruction cache I$ 526 and a data cache D$ 528 associated with core 0; an instruction cache I$ 546 and a data cache D$ 548 associated with core 1; and an instruction cache I$ 566 and a data cache D$ 568 associated with core N−1. In addition to the level 1 instruction and data caches, each core can include a level 2 (L2) cache. The level 2 caches can include an L2 cache 530 associated with core 0; an L2 cache 550 associated with core 1; and an L2 cache 570 associated with core N−1. The cores associated with the multicore processor 510 can include further components or elements. The further elements can include a level 3 (L3) cache 512. The level 3 cache, which can be larger than the level 1 instruction and data caches, and the level 2 caches associated with each core, can be shared among all of the cores. The further elements can be shared among the cores. In embodiments, the further elements can include a platform level interrupt controller (PLIC) 514. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 516. The JTAG can provide boundaries within the cores of the multicore processor. The JTAG can enable fault information to a high precision. The high-precision fault information can be critical to rapid fault detection and repair.

The multicore processor 510 can include one or more interface elements 518. The interface elements can support standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 500, the interface elements can be coupled to an interconnect. The interconnect can include a bus, a network, and so on. The interconnect can include an AXI™ interconnect 580. In embodiments, the network can include network-on-chip functionality. The AXI™ interconnect can be used to connect memory-mapped “master” or boss devices to one or more “slave” or worker devices. In the block diagram 500, the AXI interconnect can provide connectivity between the multicore processor 510 and one or more peripherals 590. The one or more peripherals can include storage devices, networking devices, and so on. The peripherals can enable communication using the AXI™ interconnect by supporting standards such as AMBA™ version 4, among other standards.

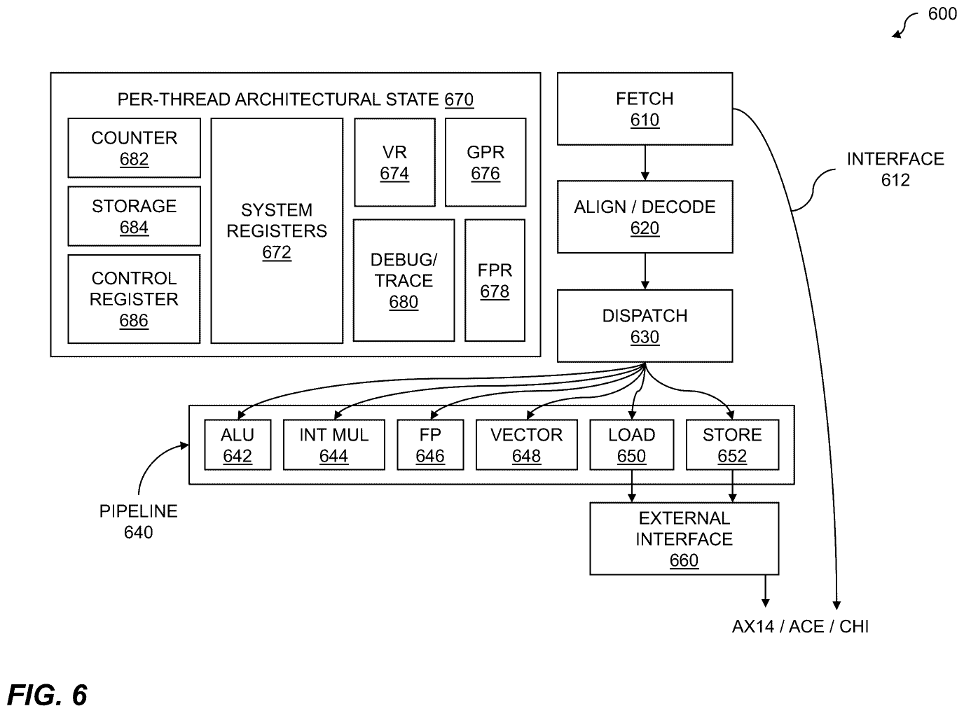

FIG. 6 is a block diagram for a pipeline. The use of one or more pipelines associated with a processor architecture can greatly enhance processing throughput. The processing throughput can be increased because multiple operations can be executed in parallel. The use of one or more pipelines supports processor error detection with assertion registers. One or more processors are accessed. Each processor within the one or more processors includes a set of assertion registers. A processor within the one or more processors executes one or more instructions. An assertion logic detects an error condition in the processor. The detecting occurs during the executing. The error condition is recorded. The recording is based on one or more bits in the set of assertion registers. A hardware interface reads the one or more bits in the set of assertion registers. The one or more bits indicate the error condition to the hardware interface.

The block diagram 600 shows a processor pipeline such as a core pipeline. The blocks within the block diagram can be configurable in order to provide varying processing levels. The varying processing levels can be based on processing speed, bit lengths, and so on. The block diagram 600 can include a fetch block 610. The fetch block can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 612. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 600 includes an align and decode block 620. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 600 can include a dispatch block 630. The dispatch block can receive decoded instruction packets from the align and decode block. The decoded instruction packets can be used to control a pipeline 640, where the pipeline can include an in-order pipeline, an out-of-order (OoO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 642, integer multiplier pipelines 644, floating-point unit (FPU) pipelines 646, vector unit (VU) pipelines 648, and so on. The dispatch unit can further dispatch instructions to pipelines that can include load pipelines 650, and store pipelines 652. The load pipelines and the store pipelines can access storage such as the common memory using an external interface 660. The external interface can be based on one or more interface standards such as the Advanced eXtensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, one or more processor cores can be configured to support multi-threading. The system block diagram can include a per-thread architectural state block 670. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 672. The system registers can be associated with individual processors or processor cores, a system comprising multiple processors or processor cores, and so on. The system registers can include exception and interrupt components, counters, etc. The per-thread architectural state can include further registers such as vector registers (VR) 674, general purpose registers (GPR) 676, and floating-point registers (FPR) 678. These registers can be used for vector operations, general purpose (e.g., integer) operations, and floating-point operations, respectively. The per-thread architectural state can include a debug and trace block 680. The debug and trace block can enable debug and trace operations to support code development, troubleshooting, and so on. In embodiments, an external debugger can communicate with a processor through a debugging interface such as a joint test action group (JTAG) interface. The per-thread architectural state can include a performance counter 682. The performance counter can be used to sample program or code execution, to generate a performance profile, and so on. The performance profile can be based on saving repeated program states. The program states can be sampled on a periodic basis and saved for analysis. In embodiments, the performance profile can be generated by the external profiling agent. The per-thread architecture can include a performance counter storage area 684. The program states, which can be sampled on a periodic basis, can be saved to the storage area, etc. The saving can be based on a counter event in the performance counter. The per-thread architecture can include a performance counter control register 686. In embodiments, the performance counter and the performance counter control register are loaded by the external profiling agent. The loading of the performance counter and the performance counter control register can be based on a particular event. The particular event can be associated with the processor core and can include a counter event, an interrupt or exception, and so on. In embodiments, the particular event can include human direction such as requesting a program profile for a program or code that is executing, analyzing an anomalous event, etc.

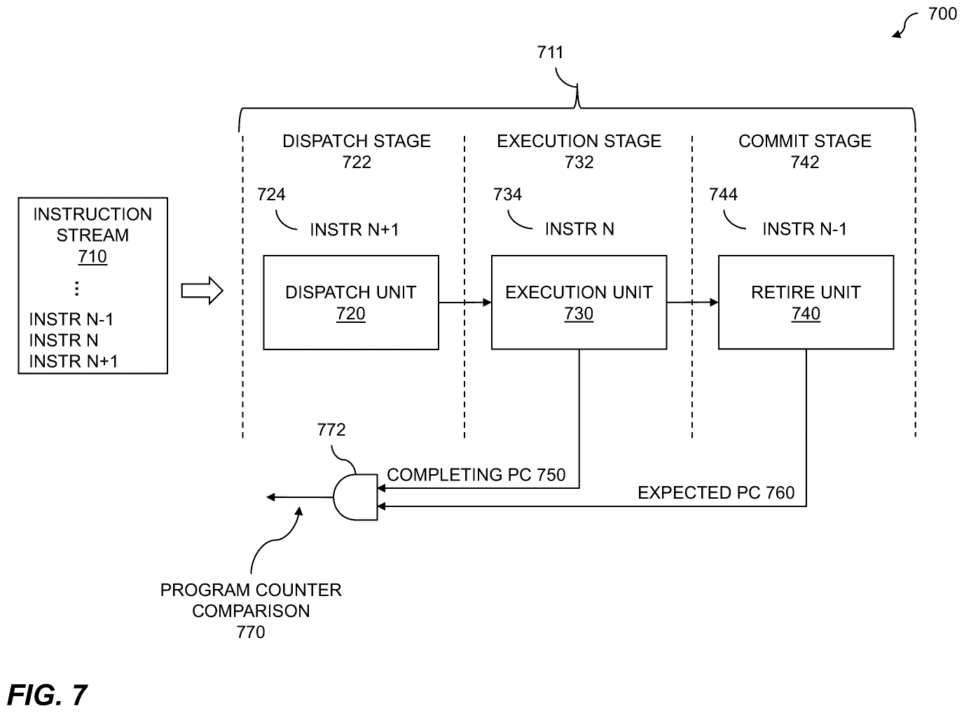

FIG. 7 is a first example of error detection. Various techniques for detecting errors can enable processor error detection with assertion registers. One or more processors are accessed. Each processor within the one or more processors includes a set of assertion registers. A processor within the one or more processors executes one or more instructions. An assertion logic detects an error condition in the processor. The detecting occurs during the executing. The error condition is recorded. The recording is based on one or more bits in the set of assertion registers. A hardware interface reads the one or more bits in the set of assertion registers. The one or more bits indicate the error condition to the hardware interface.

In example 700, the error detection is focused on a program counter comparison function. An instruction stream 710 includes a plurality of instructions, indicated as instruction N−1, instruction N, and instruction N+1. Instruction pipeline 711 includes a dispatch stage 722, an execution stage 732, and a commit stage 742. The dispatch stage 722 includes a dispatch unit 720. The execution stage 732 includes an execution unit 730. The commit stage 742 includes a retire unit 740. In the instruction pipeline 711, the execution stage is processing instruction N at 734, while the dispatch stage is processing instruction N+1 at 724, and the commit stage is processing instruction N−1 at 744. In the instruction stream 710, each instruction in the sequence of instructions has a known program counter (PC) relationship. As an example, with 32-bit instructions, the program counter can index by four bytes on sequential instructions. Thus, if instruction N−1 has a program counter value of 0x10000004, then instruction N will have a program counter value of 0x10000008, in the case of sequential instructions. The aforementioned program counter relationship can be checked by a consistency unit in disclosed embodiments. The retire unit 740 can compute an expected program counter 760. A consistency unit 772 can compare a completing program counter 750 with the expected program counter. In response to the completing program counter 750 not matching the expected program counter 760, the consistency unit 772 can assert a program counter comparison signal 770 to indicate improper operation due to a possible environmental attack. In the aforementioned example, in the retire unit 740, retiring instruction N−1 corresponding to a program counter value of 0x10000004, can cause the retire unit 740 to generate a value of expected program counter 760 of 0x10000008. Accordingly, the signal 770 can be combined, and/or routed to an external pin of a package in order to enable external circuitry to provide additional protection and/or mitigation, such as shutting off power, disconnecting interfaces, and so on.

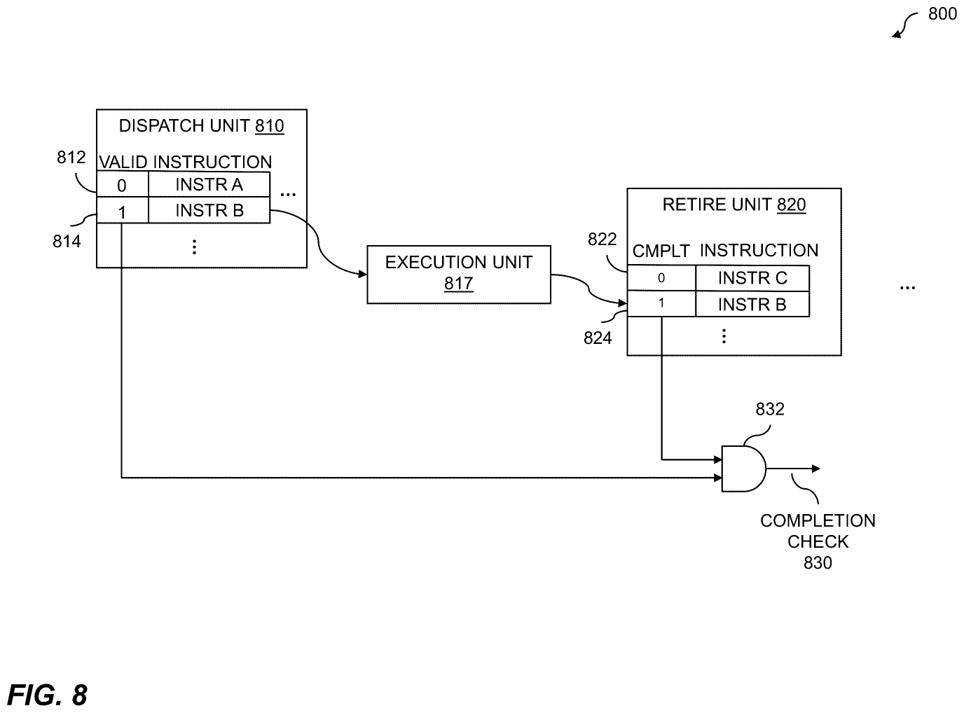

FIG. 8 is a second example of error detection. Various techniques for detecting errors can enable processor error detection with assertion registers. One or more processors are accessed. Each processor within the one or more processors includes a set of assertion registers. A processor within the one or more processors executes one or more instructions. An assertion logic detects an error condition in the processor. The detecting occurs during the executing. The error condition is recorded. The recording is based on one or more bits in the set of assertion registers. A hardware interface reads the one or more bits in the set of assertion registers. The one or more bits indicate the error condition to the hardware interface.

In example 800, the error detection is focused on a completion signal check function. The example 800 includes a dispatch unit 810. The dispatch unit 810 includes an instruction table comprising row 812 and row 814. Row 812 corresponds to instruction A, and row 814 corresponds to instruction B. The valid bit for instruction A, as shown in row 812, is 0, while the valid bit for instruction B, as shown in row 814, is 1. A valid bit set to a value of 1 indicates that the instruction is valid and ready to be executed. A valid bit set to a value of 0 indicates that the instruction is not valid. An instruction can be an instruction that has dependencies that are not yet resolved (e.g., control and/or data hazards). Once the dependencies are resolved, the valid bit is set to 1, indicating the instruction is ready to be executed. Once valid, the instruction can proceed to the execution unit 817. Once executed, the instruction can proceed to the retire unit 820. The retire unit can include an instruction table comprising row 822 and row 824. Row 822 corresponds to instruction C, and row 824 corresponds to instruction B. The completion bit for instruction C as shown in row 822, is 0, while the completion bit for instruction B, as shown in row 824, is 1. A completion bit set to a value of 1 indicates that the instruction has completed execution. A completion bit set to a value of 0 indicates that the instruction has not yet completed. A consistency unit 832 asserts a signal corresponding to a completion check 830 by comparing the completion status and valid status of an instruction in the retire unit 820, and asserting an error signal if an instruction indicated as complete in retire unit 820 is indicated as not valid in the dispatch unit 810.

The instructions can be executed out-of-order (OOO). In a pipelined processor, the instructions are divided into smaller stages, and each stage is executed in parallel by different hardware units. This allows multiple instructions to be processed simultaneously, which increases the overall performance of the processor. However, when an instruction depends on the result of a previous instruction that has not yet been completed, a pipeline stall occurs. To mitigate pipeline stalls, OOO execution can be used to enable the pipeline to continue executing instructions that are not dependent on the stalled instruction, while the stalled instruction is completed. A compiler may generate machine instructions that are out of order with respect to high-level source code that is input to the compiler, freeing a programmer from having to be concerned with low-level optimizations based on a pipelined architecture.

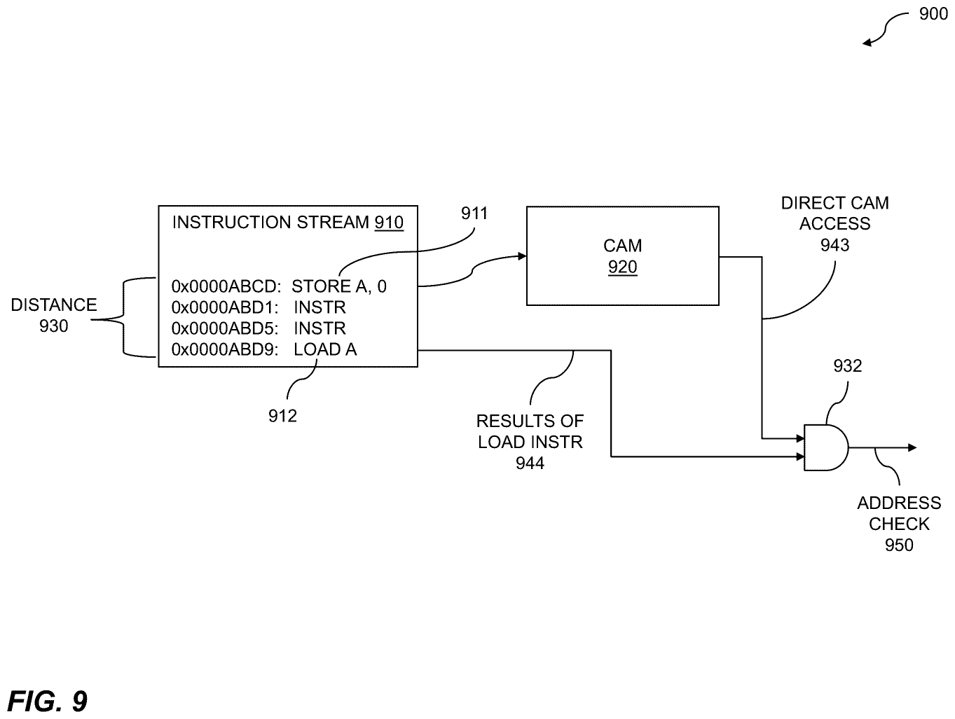

FIG. 9 is a third example of error detection. Various techniques for detecting errors can enable processor error detection with assertion registers. One or more processors are accessed. Each processor within the one or more processors includes a set of assertion registers. A processor within the one or more processors executes one or more instructions. An assertion logic detects an error condition in the processor. The detecting occurs during the executing. The error condition is recorded. The recording is based on one or more bits in the set of assertion registers. A hardware interface reads the one or more bits in the set of assertion registers. The one or more bits indicate the error condition to the hardware interface.

The example 900 focuses on error detection using an address check function. In the block diagram 900, an instruction stream 910 comprises a plurality of instructions that include a store instruction 911 and a load instruction 912. Instruction 911 and instruction 912 are separated by a distance 930, measured in instructions. As shown in instruction stream 910, instruction 912 is three instructions away from instruction 911. Thus, in block diagram 900, the distance 930 has a value of three. Instruction 911 is a store instruction, that stores data “A” in a memory, such as a content addressable memory (CAM) 920. Content-addressable memory (CAM) is a type of computer memory that allows data to be accessed based on its content rather than its memory address. In other words, it is a memory device that stores data and allows the system to search for a specific data item based on its content, rather than requiring the system to know the address where the data is stored. CAM is used in applications where rapid searches of data are necessary, including processing applications. A content-addressable memory typically includes a memory array and a comparison circuit. The memory array stores data items, while the comparison circuit compares a search data item with the data items stored in the memory array. When a match is found, the address of the matching data item is returned. CAM can be implemented using various technologies, such as static RAM, dynamic RAM, or associative memory.

In execution of the instruction sequence in instruction stream 910, first instruction 911 is executed, which is a store instruction, storing data in CAM 920. There can be some intervening instructions, followed by load instruction 912. Load instruction 912 reads the value from the CAM 920. In one or more embodiments, a consistency unit 932 compares the results of the load instruction 944 with the contents of CAM 920 via direct CAM access 943. The consistency unit 932 outputs an address check 950, which is a signal that when asserted, can indicate that the contents did not match, and indicates a potential environmental attack scenario. The asserted address check 950 can be combined with other consistency check outputs and/or can be mapped to a pin of a package to enable external circuitry to monitor the processor for an error condition. If an error condition is found, mitigative steps such as shutting down the processor and/or disconnecting interfaces, including I/O pins, network connections, serial connections, and so on, can be taken. In embodiments, the consistency check is performed when a store instruction and its corresponding load instruction are within a predetermined distance. Note that while a CAM is used as the storage in the example of FIG. 9, disclosed embodiments can perform address check functions on other types of memory, including, but not limited to dynamic random-access memory (DRAM) and static random-access memory (SRAM).

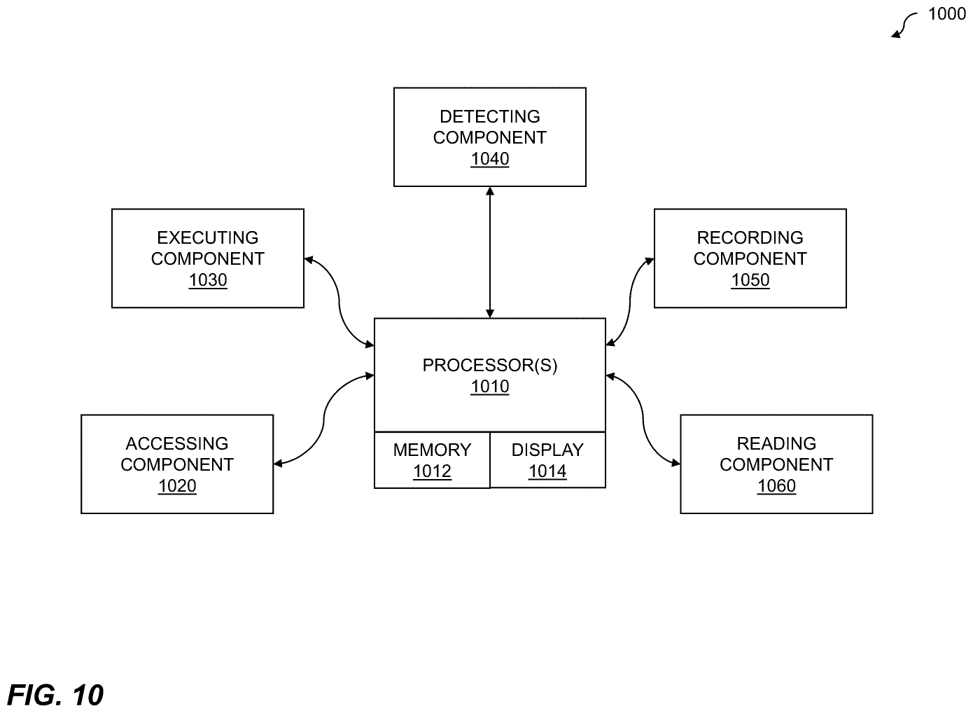

FIG. 10 is a system diagram for processor error detection with assertion registers. The system 1000 can include one or more of processors, memories, cache memories, displays, counters, and so on. The system 1000 can include one or more processors 1010. The processors can include standalone processors within integrated circuits or chips, processor cores such as cores in FPGAs or ASICs, and so on. The one or more processors can include one or more processors within a system-on-a-chip (SoC). The one or more processors 1010 are coupled to a memory 1012, which stores instructions. The memory can include one or more of local memory, cache memory, system memory, etc. The system 1000 can further include a display 1014 coupled to the one or more processors 1010. The display 1014 can be used for displaying data, instructions, operations, program states, and the like. The operations can include error detection operations, where the errors detection operations can be enabled with assertion registers. In embodiments, one or more processors 1010 are coupled to the memory 1012, wherein the one or more processors, when executing the instructions which are stored, are configured to: access the one or more processors, wherein each processor within the one or more processors includes a set of assertion registers; execute, by a processor within the one or more processors, one or more instructions; detect, by an assertion logic, an error condition in the processor, wherein the detecting occurs during the executing; record the error condition, wherein the recording is based on one or more bits in the set of assertion registers; and read, by a hardware interface, the one or more bits in the set of assertion registers, wherein the one or more bits indicate the error condition to the hardware interface.

The system 1000 can include an accessing component 1020. The accessing component 1020 includes accessing one or more processors, wherein each processor within the one or more processors includes a set of assertion registers. The one or more processors can include an integrated circuit or chip, a multichip processor, one or more cores within an integrated circuit, an FPGA, an ASIC, and so on.

The system 1000 can include an executing component 1030. The executing component 1030 includes executing, by a processor within the one or more processors, one or more instructions. The instructions that are executed can include instructions associated with an app, an application program or code, an operating system, etc. The instructions can fetch and store data, process data, communicate with devices, etc. The executing can include a communication protocol between the processor and a secondary or slave device.

The system 1000 can include a detecting component 1040. The detecting component 1040 includes detecting, by an assertion logic, an error condition in the processor, wherein the detecting occurs during the executing. The assertion logic can include logic within a processor, logic external to the processor, logic shared by two or more processors, and so on. The assertion logic can receive signals, flags, semaphores, etc. from one or more elements associated with the processor. The assertion logic can detect one or more error conditions using one or more sensors, detectors, and so on. In embodiments, the assertion logic can include a voltage detector.

The system 1000 can include a recording component 1050. The detecting component 1050 includes recording the error condition, wherein the recording is based on one or more bits in the set of assertion registers. The recording can include writing the error condition to a storage component such as a scratchpad, a register file, a cache, a shared cache, shared memory accessible to a plurality of processors, and so on. The recording is based on one or more bits in the set of assertion registers. The assertion registers can be implemented using a variety of circuit techniques including one or more D flip-flops. The D flip-flops can be implemented using static circuits, dynamic circuits, and the like. The one or more bits can include one or more sticky bits. The one or more sticky bits can include one or more persistent bits. The one or more persistent bits can remain set or reset through a change of a state associated with the processor. The one or more bits can comprise a counter. The counter can be set, reset, and so on. The counter can be incremented to indicate a number of occurrences of a type of error condition, a total number of error conditions, etc.

The system 1000 can include a reading component 1060. The reading component includes reading, by a hardware interface, the one or more bits in the set of assertion registers, wherein the one or more bits indicate the error condition to the hardware interface. The reading can be accomplished by accessing the set of assertion registers. The accessing can be accomplished by the hardware interface making a request to the processor to receive the one or more bits, an access such as a direct memory access (DMA), a referenced access using a pointer, and so on. The one or more bits can indicate the error condition to the hardware interface. Individual bits can be associated with a type of error condition, the bits can present a code that references a type of error condition, and the like. The one or more bits in the set of assertion registers can be used for a variety of purposes. In embodiments, the hardware interface can be a debugger. The debugger can be used to debug the processor, the secondary or slave device, the communication protocol used between the processor and the secondary device, etc.

The system 1000 can include a computer program product embodied in a non-transitory computer readable medium for malicious code detection, the computer program product comprising code which causes one or more processors to generate semiconductor logic for: accessing one or more processors, wherein each processor within the one or more processors includes a set of assertion registers; executing, by a processor within the one or more processors, one or more instructions; detecting, by an assertion logic, an error condition in the processor, wherein the detecting occurs during the executing; recording the error condition, wherein the recording is based on one or more bits in the set of assertion registers; and reading, by a hardware interface, the one or more bits in the set of assertion registers, wherein the one or more bits indicate the error condition to the hardware interface.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for debug comprising:
accessing one or more processors, wherein each processor within the one or more processors includes a set of assertion registers;
executing, by a processor within the one or more processors, one or more instructions;
detecting, by an assertion logic, an error condition in the processor, wherein the detecting occurs during the executing;
recording the error condition, wherein the recording is based on one or more bits in the set of assertion registers; and
reading, by a hardware interface, the one or more bits in the set of assertion registers, wherein the one or more bits indicate the error condition to the hardware interface.

2. The method of claim 1 wherein the executing includes a communication protocol between the processor and a slave device.

3. The method of claim 2 wherein the error condition comprises a data collision between the processor and the slave device.

4. The method of claim 2 wherein the error condition comprises an incorrect value in a credit buffer, wherein the credit buffer controls a number of transactions allowed between the processor and the slave device.

5. The method of claim 1 wherein the error condition comprises a compressed clock cycle within the processor.

6. The method of claim 1 wherein the error condition comprises an elongated clock cycle within the processor.

7. The method of claim 1 wherein the assertion logic comprises a voltage detector.

8. The method of claim 7 wherein the error condition comprises a voltage droop within the processor.

9. The method of claim 7 wherein the error condition comprises a voltage spike within the processor.

10. The method of claim 1 wherein the error condition comprises a full first in, first out (FIFO) register.

11. The method of claim 1 wherein the error condition comprises an empty FIFO register.

12. The method of claim 1 wherein the error condition comprises an incorrect pointer.

13. The method of claim 1 wherein the set of assertion registers comprises one or more D flip-flops.

14. The method of claim 1 wherein the one or more bits comprise one or more sticky bits.

15. The method of claim 14 wherein the one or more sticky bits comprise one or more persistent bits.

16. The method of claim 15 wherein the one or more sticky bits retain their value after a warm reset of the processor.

17. The method of claim 1 wherein the one or more bits comprise a counter.

18. The method of claim 17 wherein the recording includes incrementing the counter.

19. The method of claim 18 further comprising triggering an error signal when the counter exceeds a first threshold.

20. The method of claim 1 wherein the hardware interface is a debugger.

21. A computer program product embodied in a non-transitory computer readable medium for debug, the computer program product comprising code which causes one or more processors to generate semiconductor logic for:
accessing one or more processors, wherein each processor within the one or more processors includes a set of assertion registers;
executing, by a processor within the one or more processors, one or more instructions;
detecting, by an assertion logic, an error condition in the processor, wherein the detecting occurs during the executing;
recording the error condition, wherein the recording is based on one or more bits in the set of assertion registers; and
reading, by a hardware interface, the one or more bits in the set of assertion registers, wherein the one or more bits indicate the error condition to the hardware interface.

22. A computer system for debug comprising:
a memory which stores instructions;
one or more processors coupled to the memory wherein the one or more processors, when executing the instructions which are stored, are configured to:
access the one or more processors, wherein each processor within the one or more processors includes a set of assertion registers;
execute, by a processor within the one or more processors, one or more instructions;
detect, by an assertion logic, an error condition in the processor, wherein the detecting occurs during the executing;
record the error condition, wherein the recording is based on one or more bits in the set of assertion registers; and
read, by a hardware interface, the one or more bits in the set of assertion registers, wherein the one or more bits indicate the error condition to the hardware interface.
